(19) United States
(12) Patent Application Publication
(10) Pub. No.: US 2025/0355100 A1
(43) Pub. Date: Nov. 20, 2025

(54) VEHICLE DETECTION METHOD AND APPARATUS THEREOF

(71) Applicant: MediaTek Singapore Pte. Ltd., Singapore (SG)

(72) Inventors: Tianpeng YUAN, Beijing (CN); Fengyu CHE, Beijing (CN); Chao GUO, Beijing (CN); Pan GAO, Beijing (CN); Jinnan WANG, Beijing (CN)

(21) Appl. No.: 18/673,539

(22) Filed: May 24, 2024

(30) Foreign Application Priority Data
May 20, 2024 (CN) 202410627064.8

(51) Int. Cl. G01S 11/10; H04W 4/42

(52) U.S. Cl. CPC G01S 11/10; H04W 4/42

(57) ABSTRACT

A vehicle detection method is provided. The vehicle detection method may be applied to an apparatus in a vehicle. The vehicle detection method may include the following steps. A processor of the apparatus may monitor Doppler-spread information and timing-advance (TA) information of the apparatus. Then, the processor may determine that the vehicle is entering or leaving a station according to the Doppler-spread information, the TA information, or both.

### CROSS-REFERENCE TO RELATED APPLICATIONS

This application claims the benefits of CN Patent Application No. 202410627064.8, filed on May 20, 2024, the entirety of which is incorporated by reference herein.

### BACKGROUND OF THE INVENTION

### Field of the Invention

The invention generally relates to vehicle detection technology, and more particularly, to the determining the vehicle is entering or leaving a station.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

Metro rail rapid transit, or subway, systems are among the most important methods of public transportation nowadays. There are two typical communication scenarios, tunnel and platform in the subway. The radio network scenarios for user equipment (UE) may be different in these two communication scenarios. For example, the platform cell may have better performance than a tunnel cell, e.g., the platform cell may have higher throughput, lower latency, and lower power consumption. Therefore, if the UE can know that the subway is entering or leaving the station (or platform), the UE may optimize its operations to improve user experience.

Therefore, how to determine that the subway train is entering or leaving a station is a topic that is worthy of discussion.

### BRIEF SUMMARY OF THE INVENTION

Vehicle detection methods and apparatuses are provided to overcome the problems mentioned above.

An embodiment of the invention provides a vehicle detection method. The vehicle detection method may be applied to an apparatus or a vehicle. The vehicle detection method may include the following steps. A processor of the apparatus may monitor Doppler-spread information and timing-advance (TA) information of the apparatus. Then, the processor may determine that the vehicle is entering or leaving a station according to the Doppler-spread information, the TA information, or both.

According to some embodiments, the Doppler-spread information comprises a Doppler-spread indicator which indicates a Doppler-spread value.

According to some embodiments, the processor may calculate the moving average corresponding to the Doppler-spread indicator in a moving window.

According to some embodiments, the processor may determine that the vehicle is entering the station in response to the moving average being lower than the first threshold, or the moving average is lower than the second threshold and the moving average decreases for a default number of moving windows continuously. The first threshold is lower than the second threshold.

According to some embodiments, the processor may determine that the vehicle is leaving the station in response to the moving average being higher than the third threshold, or the moving average is higher than the fourth threshold and the moving average increases for the default number of moving windows continuously. The third threshold is higher than the fourth threshold.

According to some embodiments, the TA information may comprise at least one TA indicator which indicates a TA slope and a TA standard deviation.

According to some embodiments, the processor may obtain TA configurations from the network node for a period of time. The processor may perform an averaging calculation on some of the TA values indicated by the TA configurations within a default time.

According to some embodiments, the processor may calculate the TA slope and the TA standard deviation according to the TA values.

According to some embodiments, the processor may determine that the vehicle is entering the station in response to a variance of the TA slope having been lower than a threshold for the default number of moving windows continuously, or the TA standard deviation having continuously been lower than another threshold for the default number of moving windows.

According to some embodiments, the processor may determine that the vehicle is leaving the station in response to a variance the TA slope having continuously been higher than a threshold for the default number of moving windows.

An embodiment of the invention provides an apparatus for vehicle detection. The apparatus may include a transceiver and a processor. The transceiver may wirelessly communicate with a network node. The processor is coupled to the transceiver. The processor is configured to monitor Doppler-spread information and timing-advance (TA) information of the apparatus and determine that the vehicle is entering or leaving a station according to the Doppler-spread information, the TA information, or both.

Other aspects and features of the invention will become apparent to those with ordinary skill in the art upon review of the following descriptions of specific embodiments of the vehicle detection method and apparatus for vehicle detection.

### BRIEF DESCRIPTION OF DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a flow chart illustrating a vehicle detection method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

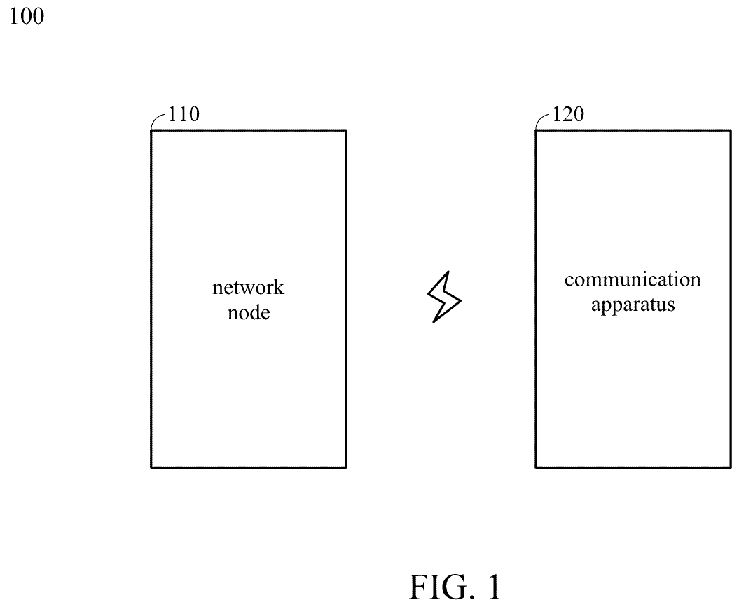

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point, an access terminal, but the invention should not be limited thereto. In the embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto.

In the embodiments of the invention, the communication apparatus 120 may be user equipment (UE), a smartphone, Personal Data Assistant (PDA), pager, laptop computer, desktop computer, wireless handset, or any computing device that includes a wireless communications interface. In the embodiments of the invention, the communication apparatus 120 may be located in a vehicle, e.g., subway, metro, and so on.

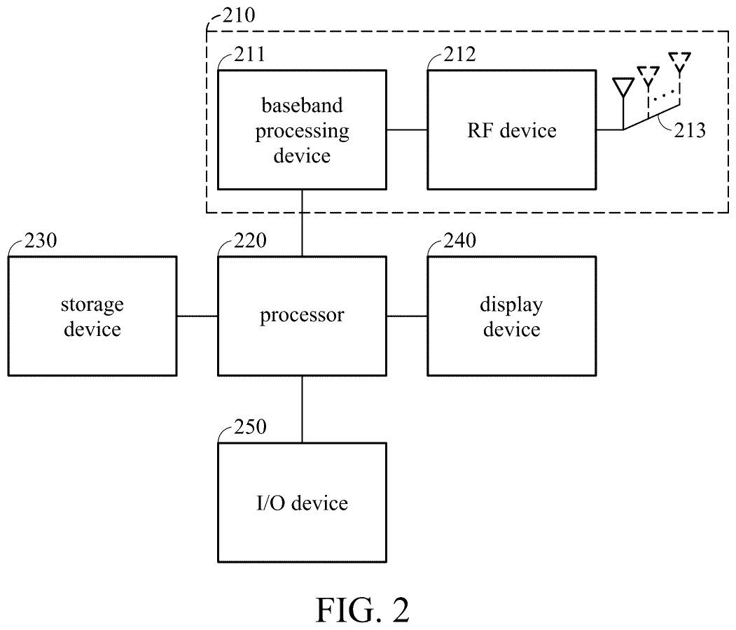

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, and an Input/Output (I/O) device 250.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, and the I/O device 250 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the wireless transceiver 210 may be configured in a modem (MD) of the communication apparatus 200, and the processor 220 may be configured in an application processor (AP) of the communication apparatus 200.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

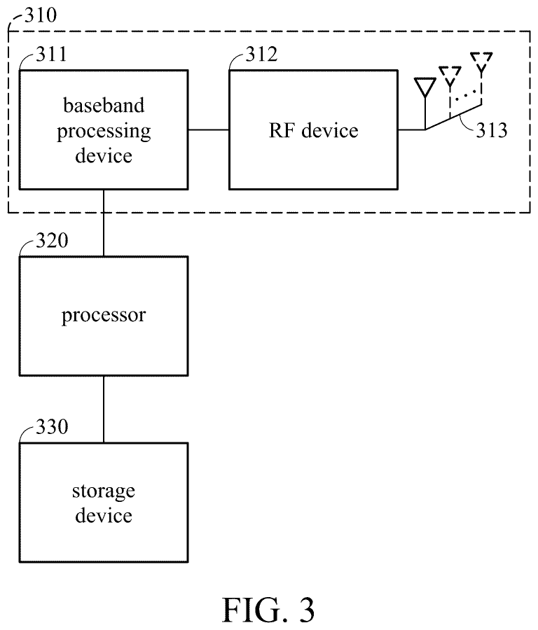

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, when the communication apparatus 120 is located in a vehicle (e.g., a subway), the communication apparatus 120 may monitor Doppler-spread information and timing-advance (TA) information of the communication apparatus 120. Then, the communication apparatus 120 may determine that the vehicle is entering or leaving a station according to the Doppler-spread information, the TA information, or both.

According to an embodiment of the invention, the Doppler-spread information may comprise Doppler-spread indicator which may indicate Doppler-spread value corresponding to the communication apparatus 120. In an example, the Doppler-spread indicator may indicate a plurality of gears or levels. Different gears (or levels) may correspond to different Doppler-spread values.

When the communication apparatus 120 monitors the Doppler-spread information, the communication apparatus 120 may calculate the moving average corresponding to the Doppler-spread indicator in a moving window. Specifically, during a moving window, the communication apparatus 120 may obtain a plurality of Doppler-spread values corresponding to the communication apparatus 120. Then, the communication apparatus 120 may perform an averaging calculation on the Doppler-spread values to generate the moving average. The moving window may move based on a moving step. Accordingly, during the next moving window (i.e., the moving window moves one moving step), the communication apparatus 120 may also obtain another moving average corresponding to the Doppler-spread indicator in the next moving window. In an example, the length of the moving window and the length of the moving step may be 5 second (5 s) and 2 s respectively, but the invention should not be limited thereto.

After the communication apparatus 120 obtains the moving average (or moving averages), the communication apparatus 120 may determine the vehicle is entering or leaving a station according to the moving average (or moving averages).

In an embodiment, when the value of the moving average is changing from high to low, and the value of the moving average is lower than the first threshold MDth1, the communication apparatus 120 may determine that the vehicle is entering the station. In another embodiment, when the value of the moving average is changing from high to low, and the value of the moving averages is lower than the second threshold MDth2 (but not lower than the first threshold MDth1) and the value of the moving average decreases for the default number of moving windows continuously, the communication apparatus 120 may also determine that the vehicle is entering the station. For example, if the default number is 3, when the value of the moving average is lower than the second threshold MDth2 (but not lower than the first threshold MDth1) and the value of the moving average decreases for 3 continuous moving windows, the communication apparatus 120 may determine that the vehicle is entering the station. The first threshold MDth1 may be lower than the second threshold MDth2, e.g., the first threshold MDth1 may correspond to 30 Hz Doppler-spread and the second threshold MDth2 may correspond to 50 Hz Doppler spread, but the invention should not be limited thereto. When the value of the moving average is lower than the first threshold MDth1, it may mean that the speed of the communication apparatus 120 is low enough. Therefore, the communication apparatus 120 may only need to determine one moving average in moving window.

In an embodiment, when the value of the moving average is changing from low to high, and the value of the moving average is higher than the third threshold MDth3, the communication apparatus 120 may determine that the vehicle is leaving the station. In another embodiment, when the value of the moving average is changing from low to high, and the value of the moving average is higher than the fourth threshold MDth4 (but not higher than the third threshold MDth3) and the value of the moving average increases for the default number of moving windows continuously, the communication apparatus 120 may also determine that the vehicle is leaving the station. For example, if the default number is 3, when the value of the moving average is higher than the fourth threshold MDth4 (but not higher than the third threshold MDth3) and the value of the moving average increases for 3 continuous moving windows, the communication apparatus 120 may determine that the vehicle is leaving the station. The third threshold MDth3 may be higher than the fourth threshold MDth4, e.g., the third threshold MDth3 may correspond to 80 Hz Doppler-spread and the fourth threshold MDth4 may correspond to 70 Hz Doppler spread, but the invention should not be limited thereto. When the value of the moving average is higher than the third threshold MDth3, it may mean that the speed of the communication apparatus 120 is higher enough. Therefore, the communication apparatus 120 may only need to determine one moving average in moving window

According to an embodiment of the invention, the TA information may comprise at least one TA indicator. The TA indicator may indicate a TA slope and a TA standard deviation in a moving window.

When the communication apparatus 120 monitors the TA information, the communication apparatus 120 may obtain the TA configurations from the network node 110 for a period of time. Specifically, each TA configuration from the network node 110 may indicate a TA value. The communication apparatus 120 may obtain or collect the TA values for a period of time (e.g., 10 s, but the invention should not be limited thereto). In addition, in an embodiment, in order to obtain the precise TA indicator in later operations, the communication apparatus 120 may further perform an averaging calculation on the TA values within a default time for all collected TA values. For example, if the default time is 1 s, when there are more than one TA values within Is, the communication apparatus 120 may perform an averaging calculation on these TA values.

Then, the communication apparatus 120 may calculate the TA slope and the TA standard deviation according to the TA values which have processed by the communication apparatus 120 (e.g., perform an averaging calculation).

In an embodiment of the invention, before calculating the TA slope and the TA standard deviation according to the TA values, the communication apparatus 120 may further filter the TA values based on the handover time (i.e., the time of happening the handover) or change point (i.e. the point of the TA slope changing from the positive slope to negative slope, or the point of the TA slope changing from the positive slope to negative slope).

In an embodiment, when the TA slope is changing from high to low, and a variation of the TA slope have continuously been lower than a threshold for the default number (e.g., 3) of the moving window, the communication apparatus 120 may determine that the vehicle is entering the station. For example, if the default number is 3, when the variation of the TA slope has been lower than a threshold during 3 continuous moving windows, the communication apparatus 120 may determine that the vehicle is entering the station.

In another embodiment, when the TA standard deviation having continuously been lower than a threshold (e.g., 6.5) for the default number (e.g., 3) of moving window, the communication apparatus 120 may also determine that the vehicle is entering the station. For example, if the default number is 3, when the TA standard deviation has been lower than a threshold (e.g., 6.5) during 3 continuous moving windows, the communication apparatus 120 may determine that the vehicle is entering the station.

In an embodiment, when the TA slope is changing from low to high, and a variation of the TA slope have continuously been higher than a threshold for the default number (e.g., 3) of the moving window (e.g., the threshold is 3 Ts/s, Ts=1/(2048*15000)s, which is defined in 3GPP Spec, and the threshold will be updated with the currently calculated TA slope when certain conditions are met), the communication apparatus 120 may determine that the vehicle is leaving the station. For example, if the default number is 3, when the variation of the TA slope has been higher than a threshold during 3 continuous moving windows, the communication apparatus 120 may determine that the vehicle is leaving the station.

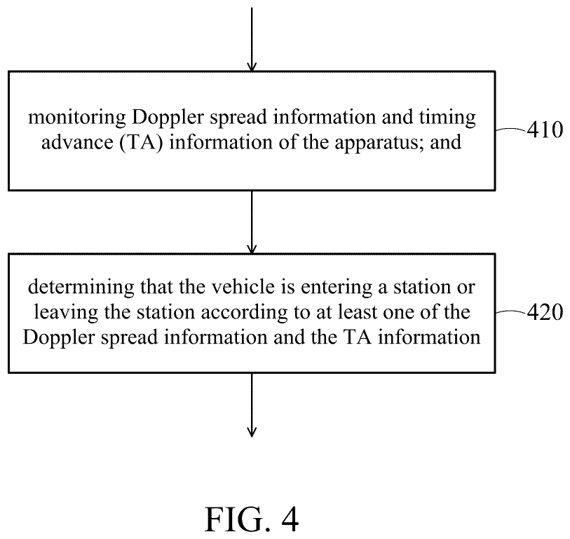

FIG. 4 is a flow chart illustrating a vehicle detection method according to an embodiment of the invention. The vehicle detection can be applied in the communication apparatus 120 of the wireless communication system 100. As shown in FIG. 4, in step S410, a processor of the communication apparatus 120 may monitor Doppler-spread information and timing-advance (TA) information of the communication apparatus 120.

In step S420, the processor of the communication apparatus 120 may determine that the vehicle is entering or leaving a station according to at least one of the Doppler-spread information and the TA information.

According to an embodiment of the invention, in the vehicle detection method, the Doppler-spread information comprises a Doppler-spread indicator which indicates a Doppler-spread value.

According to an embodiment of the invention, in the vehicle detection method, the processor may calculate the moving average corresponding to the Doppler-spread indicator in a moving window.

According to an embodiment of the invention, in the vehicle detection method, the processor may determine that the vehicle is entering the station in response to the moving average being lower than the first threshold, or the moving average is lower than the second threshold and the moving average decreases for the default number of moving windows continuously. The first threshold is lower than the second threshold.

According to an embodiment of the invention, in the vehicle detection method, the processor may determine that the vehicle is leaving the station in response to the moving average being higher than the third threshold, or the moving average is higher than the fourth threshold and the value of the moving average increases for the default number of moving windows continuously. The third threshold is higher than the fourth threshold.

According to an embodiment of the invention, in the vehicle detection method, the TA information may comprise at least one TA indicator which indicates a TA slope and a TA standard deviation.

According to an embodiment of the invention, in the vehicle detection method, the processor may obtain TA configurations from the network node for a period of time. The processor may perform an averaging calculation on some of the TA values indicated by the TA configurations within a default time.

According to an embodiment of the invention, in the vehicle detection method, the processor may calculate the TA slope and the TA standard deviation according to the TA values.

According to an embodiment of the invention, in the vehicle detection method, the processor may determine that the vehicle is entering the station in response to the variance of the TA slope having been continuously lower than a threshold for the default number of moving windows. Alternatively, the TA standard deviation may have continuously been lower than another threshold for the default number of moving windows.

According to an embodiment of the invention, in the vehicle detection method, the processor may determine that the vehicle is leaving the station in response to a variance of the TA slope having continuously been higher than a threshold for the default number of moving windows.

In the vehicle detection method provided in the embodiments of the invention, the communication apparatus can determine that the subway train is entering or leaving a station according to the Doppler-spread information, the TA information, or both corresponding to the communication apparatus. Therefore, the communication apparatus can optimize its operations based on the determination result (i.e., the subway train is entering or leaving a station) to improve the user experience.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A vehicle detection method, applied in an apparatus in a vehicle, comprising:
monitoring, by a processor of the apparatus, Doppler-spread information and timing-advance (TA) information of the apparatus; and
determining, by the processor, that the vehicle is entering or leaving a station according to at least one of the Doppler-spread information and the TA information.

2. The vehicle detection method of claim 1, wherein the Doppler-spread information comprises a Doppler-spread indicator which indicates a Doppler-spread value.

3. The vehicle detection method of claim 2, wherein the monitoring the Doppler-spread information further comprises:
calculating, by the processor, a moving average corresponding to the Doppler-spread indicator in a moving window.

4. The vehicle detection method of claim 3, further comprising:
determining, by the processor, that the vehicle is entering the station in response to the moving average being lower than a first threshold, or in response to the moving average is lower than a second threshold and the moving average decreases for a default number of moving windows continuously,
wherein the first threshold is lower than the second threshold.

5. The vehicle detection method of claim 3, further comprising:
determining, by the processor, that the vehicle is leaving the station in response to the moving average being higher than a third threshold, or in response to the moving average is higher than a fourth threshold and the moving average increases for a default number of moving windows continuously,
wherein the third threshold is higher than the fourth threshold.

6. The vehicle detection method of claim 1, wherein the TA information comprises at least one TA indicator which indicates a TA slope and a TA standard deviation.

7. The vehicle detection method of claim 6, wherein the monitoring the TA information further comprises:
obtaining, by the processor, TA configurations from the network node for a period of time; and
calculating, by the processor, the TA slope and the TA standard deviation according to TA values indicated by the TA configurations.

8. The vehicle detection method of claim 7, further comprising:
performing, by the processor, an averaging calculation on some of the TA values within a default time.

9. The vehicle detection method of claim 7, further comprising:
determining, by the processor, that the vehicle is entering the station in response to a variance of the TA slope having continuously been lower than a threshold for a default number of moving windows, or in response to the TA standard deviation having continuously been lower than another threshold for a default number of moving windows.

10. The vehicle detection method of claim 7, further comprising:
determining, by the processor, that the vehicle is leaving the station in response to a variance of the TA slope having continuously been higher than a threshold for a default number of moving windows.

11. An apparatus for vehicle detection, comprising:
a transceiver, wirelessly communicating with a network node; and
a processor, coupled to the transceiver and configured to:
monitor Doppler-spread information and timing-advance (TA) information of the apparatus; and
determine that the vehicle is entering or leaving a station according to at least one of the Doppler-spread information and the TA information.

12. The apparatus of claim 11, wherein the Doppler-spread information comprises a Doppler-spread indicator which indicates a Doppler-spread value.

13. The apparatus of claim 12, wherein the processor is further configured to:
calculate a moving average corresponding to the Doppler-spread indicator in a moving window.

14. The apparatus of claim 13, wherein the processor is further configured to:
determine that the vehicle is entering the station in response to the moving average being lower than a first threshold, or in response to the moving average is lower than a second threshold and the moving average decreases for a default number of moving windows continuously,
wherein the first threshold is lower than the second threshold.

15. The apparatus of claim 13, wherein the processor is further configured to:
determine that the vehicle is leaving the station in response to the moving average being higher than a third threshold, or in response to the moving average is higher than a fourth threshold and the moving average increases for a default number of moving windows continuously,
wherein the third threshold is higher than the fourth threshold.

16. The apparatus of claim 11, wherein the TA information comprises at least one TA indicator which indicates a TA slope and a TA standard deviation.

17. The apparatus of claim 16, wherein the processor is further configured to:
obtain, via the transceiver, TA configurations from the network node for a period of time; and
calculate the TA slope and the TA standard deviation according to TA values indicated by the TA configurations.

18. The apparatus of claim 17, wherein the processor is further configured to:
perform an averaging calculation on some of the TA values within a default time.

19. The apparatus of claim 17, wherein the processor is further configured to:
determine that the vehicle is entering the station in response to a variance of the TA slope having continuously been lower than a threshold for a default number of moving windows, or in response to the TA standard deviation having continuously been lower than another threshold for a default number of moving windows.

20. The apparatus of claim 17, wherein the processor is further configured to:
determine that the vehicle is leaving the station in response to a variance of the TA slope having continuously been higher than a threshold for a default number of moving windows.
